(19) United States
(12) Patent Application Publication
(10) Pub. No.: US 2015/0194645 A1
(43) Pub. Date: Jul. 9, 2015

(54) PORTABLE STORAGE CONTAINER FOR AN ELECTRICAL ENERGY DEVICE

(71) Applicant: RFA Brands, LLC dba myCharge, Birmingham, MI (US)

(72) Inventors: Roman S. Ferber, West Bloomfield, MI (US); Hing Wah Tsang, Ajax (CA)

(21) Appl. No.: 14/148,004

(22) Filed: Jan. 6, 2014

(51) Int. Cl. H01M 2/10

(52) U.S. Cl. CPC H01M 2/105

(57) ABSTRACT

A container for storing an electrical energy device including a first housing portion and a second housing portion cooperating with the first housing portion to form a cavity configured to receive the energy device therein. At least one of the first housing portion and the second housing portion having a generally cylindrical shape with a neck and a shoulder formed adjacent a first end thereof.

### FIELD OF THE INVENTION

The present invention relates to a portable energy container, and more particularly to a portable energy container for storing an energy device for charging electronic devices.

### BACKGROUND OF THE INVENTION

As commonly known, electronic devices, such as mobile electronic devices (e.g. mobile phones, tablet computers, cameras, portable game consoles, and the like), are typically operated by internal energy sources such as rechargeable batteries. The batteries are known to have a limited power life. In order to recharge the batteries, the electronic devices are typically connected to an energy source for recharging the battery when the battery is at a low energy state. The energy source can be an electrical wall outlet or another electronic device such as a laptop computer or desktop computer. The electronic device typically includes an electrical cord or adaptor that connects the electronic device to the energy source. Therefore, once the battery has reached a low energy state, a user of the electronic device must connect the electronic device to the energy source and recharge the battery in order to continue to use the electronic device.

It is especially inconvenient when an electronic device reaches a low energy state when a user is traveling and energy sources are not readily available or when a user does not have a cord or adapter readily available to connect the electronic device to the energy source to recharge the battery of the electronic device. Therefore, it is desirable to produce a readily available and easy to use portable energy device providing an energy source for an electronic device. Furthermore, it is desirable to have a portable container for containing and transporting the portable energy device for use with electronic devices, wherein the container is compact, provides easy access to the energy device, and is easily manufactured.

### SUMMARY OF THE INVENTION

Concordant and congruous with the present invention, a portable energy container for containing and transporting an energy device has surprisingly been discovered.

According to an embodiment a container for storing an electrical energy device is disclosed. The portable energy container includes a first housing portion and a second housing portion cooperating with the first housing portion to form a cavity configured to receive the energy device therein. At least one of the first housing portion and the second housing portion has a generally cylindrical shape with a neck and a shoulder formed adjacent a first end thereof.

According to another embodiment a container for storing an electrical energy device includes a first housing portion and a second housing portion cooperating with the first housing portion to form a cavity configured to receive the energy device therein. The container further includes an outer layer at least partially encompassing the first housing portion and the second housing portion and releasably seating the first housing portion to the second housing portion.

According to a further embodiment, an electrical energy device is disclosed. The electrical energy device includes a first end and a second end. At least one of a neck and a shoulder is formed adjacent the first end. The electrical energy device further includes a generally cylindrical portion formed adjacent the second the second end, wherein at least a portion of one of the neck, the shoulder, and the generally cylindrical portion is configured to provide an electrical energy source.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a front elevational view of a portable energy container according to an embodiment of the invention;

FIG. 2 is a cross-sectional view taken along the line 2-2 of FIG. 1;

FIG. 3 is a cross-sectional view taken along the line 3-3 of FIG. 1;

FIG. 4 is an exploded right side perspective view of the portable energy container of FIG. 1;

FIG. 4a is an enlarged fragmentary perspective view of a portion of an energy device disposed within the portable energy container of FIG. 4;

FIG. 5 is a top perspective view of a portable energy container having an outer layer according to an embodiment of the invention;

FIG. 6 is a partially exploded top perspective view of the portable energy container of FIG. 5 with the outer layer partially removed from the portable energy container;

FIG. 7 is an exploded top perspective view of a portable energy container according to another embodiment of the invention;

FIG. 8 is an exploded top perspective view of a portable energy container according to another embodiment of the invention; and

FIG. 9 is an exploded top perspective view of a portable energy container according to another embodiment of the invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

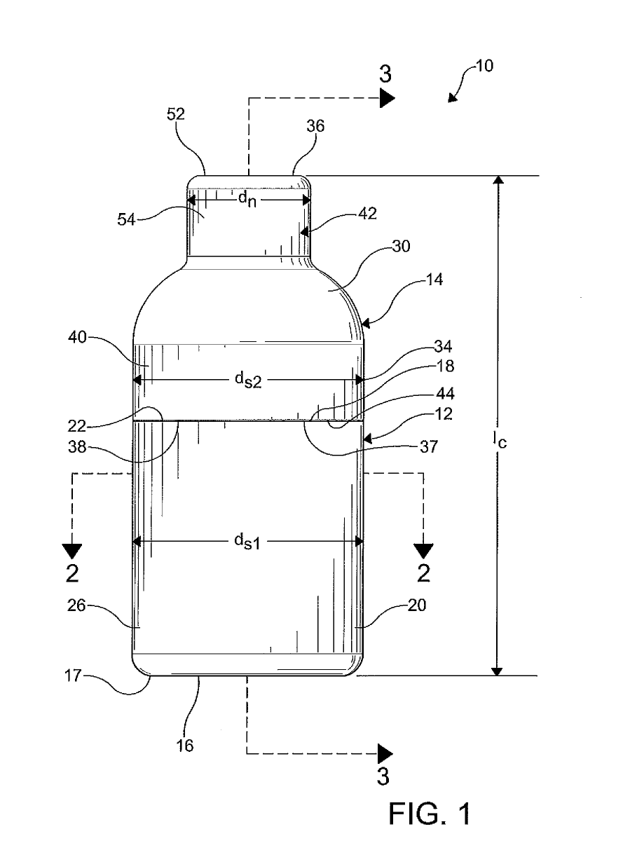

FIGS. 1-6 illustrate a container 10 for storing and transporting an energy device 100. The container 10 is a two-part housing configuration including a first housing portion 12 cooperating with a second housing portion 14 to form a cavity to receive the energy device 100, wherein the container 10 shown has a shape of a generally cylindrical bottle. The energy device 100 provides an energy source for charging an energy source for an electronic device such as a mobile electronic device. The electronic device can be a smartphone, such as an iPhone® smartphone manufactured by Apple, Inc. of Cupertino, Calif.; ANDROID™ smartphone manufactured by Google, Inc. of Mountain View, Calif.; Blackberry™ mobile phone manufactured by Research In Motion of Waterloo, Ontario; GALAXY™ mobile devices manufactured by Samsung Corp. of Seoul, South Korea; smartphones manufactured by LG® Electronics, Inc. of San Diego, Calif., HTC Corporation of Taoyuan, Taiwana, or Nokia Corporation, Espoo, Finland; or any other smartphone or mobile phone device. The mobile electronic device can also be any other mobile electronic device such as a tablet computer (e.g. iPad® tablet manufactured by Apple, Inc. of Cupertino, Calif.), a game console, laptop computer, camera, or any other electronic device known now or later discovered.

According to an embodiment shown in FIGS. 1-4, the first housing portion 12 has a closed end 16 and an open end 18. A base wall 17 forms the closed end 16 of the first housing portion 12. A sidewall 20 extends from and is integrally formed with the base wall 17 and includes a lip 22 at the open end 18 of the first housing portion 12 defining an opening 19. The first housing portion 12 has an inner surface 24 and an outer surface 26. The inner surface 24 of the first housing portion 12 defines a cavity 28 for receiving a portion of the energy device 100. In the embodiment shown, the sidewall 20 of the first housing portion 12 is defined by an annular wall to form a substantially cylindrical shape of the first housing portion 12. However, the first housing portion 12 can have any shape as desired such as a spherical shape, a rectangular prism shape, a conical shape, an obround shape, and an ovular shape or other shape as desired. Additionally, the sidewall 20 of the first housing portion 12 can be defined by any number of walls extending from the base wall 17 such as four substantially planar walls to form a substantially rectangular shape, for example.

The second housing portion 14 has a closed end 36, an open end 38, an inner surface 32, and an outer surface 34. The inner surface 32 of the second housing portion 14 defines a cavity 35 for receiving at least a portion of the energy device 100. The second housing portion 14 further includes a sidewall 40, a neck 42 adjacent the closed end 36, and a shoulder 30 disposed between and integrally formed with the sidewall 40 and the neck 42. The sidewall 40 includes a lip 44 defining an opening 46 at the open end 38 of the second housing portion 14. In the embodiment shown, the sidewall 40 of the second housing portion 14 is defined by an annular wall to form a substantially cylindrical shape. However, the sidewall 40 of the second housing portion 14 can have any shape as desired such as a spherical shape, a rectangular prism shape, a conical shape, an obround shape, and an ovular shape or other shape as desired. Additionally, the sidewall 40 of the second housing portion 14 can be defined by any number of walls to form any shape as desired such four walls to form a substantially rectangular shape, for example.

In the embodiment shown, the neck 42 includes a cap 52 and a neck wall 54 integrally formed with and extending from the cap 52. However, the cap 52 can be separately formed from the neck wall 54 of the neck 42 and configured to facilitate opening of the container 10. The neck wall 54 can be formed by an annular wall to form a substantially cylindrical shape. The neck 42 has an outer diameter dₙ less than an outer diameter dₛ₂ of the sidewall 40. The neck 42 is configured to correspond to a shape of a portion of the energy device 100. For example, the neck 42 has a cylindrical shape to correspond to the energy device 100 having a cylindrical shape. An inner diameter dₙᵢ of the neck 42 substantially corresponds to a diameter dₑ of the cylindrical shaped energy device 100. However, the neck 42 can have any shape as desired such as a spherical shape, a rectangular prism shape, an ovular shape, an oblong shape or other shape as desired to correspond to the shape of the energy device 100. The shoulder 30 is generally arcuate in shape and tapers from the sidewall 40 of the second housing portion 14 towards the neck 42 and transitions a diameter of the second housing portion 14 from the outer diameter dₛ₂ of the sidewall 40 to the outer diameter dₙ of the neck 42. A portion 48 of the neck wall 54 may extend inwardly towards the cavity 35 of the second housing portion 14 from an interface of the neck 42 and the shoulder 30 to facilitate stabilizing the energy device 100 within the container 10.

The outer diameter dₛ₂ of the sidewall 40 of the second housing portion 14 is substantially equal to an outer diameter dₛ₁ of the sidewall 20 of the first housing portion 12. The lip 22 of the first housing portion 12 is configured to cooperate with the lip 44 of the second housing portion 14 to join the first housing portion 12 and the second housing portion 14 so the cavity 28 of the first housing portion 12 and the cavity 35 of the second housing portion 14 form the cavity of the container 10 configured to receive the energy device 100 The outer surface 26 of the first housing portion 12 is substantially continuous with the outer surface 34 of the second housing portion 14 and the inner surface 24 of the first housing portion 12 is substantially continuous with the inner surface 32 of the second housing portion 14. In the embodiment shown, a groove or female step 27 is formed on the lip 22 of the first housing portion 12 to receive a male step 37 formed on the lip 44 of the second housing portion 14. The groove 27 and the male step 37 militate against relative movement between the second housing portion 14 and the first housing portion 12 when assembled. However, it is understood the groove 27 can be formed on the lip 44 of the second housing portion 14 and the male step 37 can be formed on the lip 22 of the first housing portion 12.

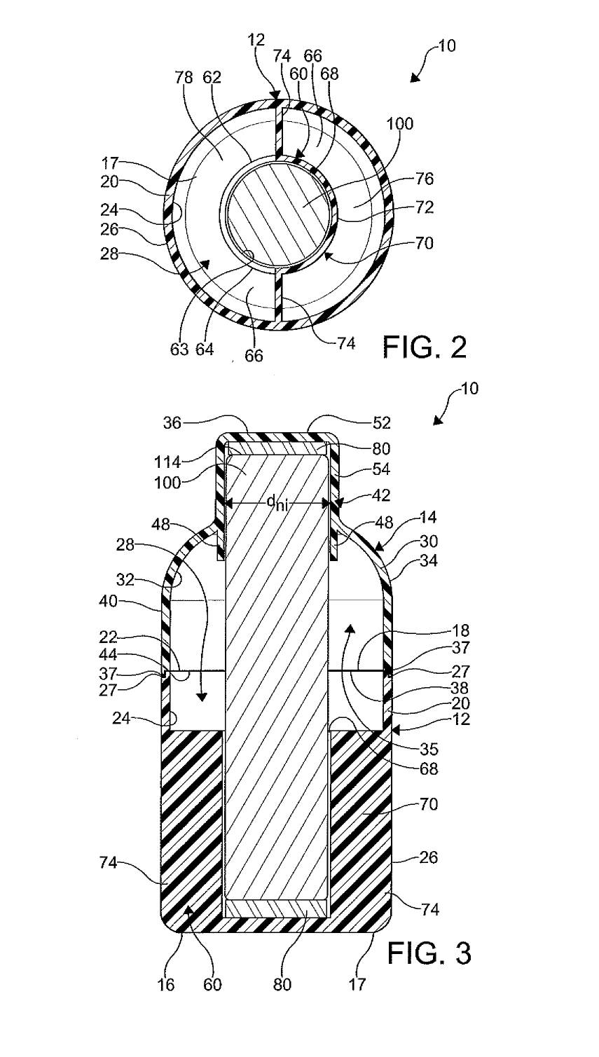

As shown in FIGS. 2-4, the first housing portion 12 can include a retaining feature 60 disposed in the cavity 28 thereof. The retaining feature 60 includes a wall 62 integrally formed with and extending from the base wall 17 of the first housing portion 12. The wall 62 extends substantially perpendicularly with respect to the base wall 17 and has an inner surface 63 and an outer surface 64. The outer surface 64 of the wall 62 cooperates with the inner surface 24 of the first housing portion 12 to form a channel 66. The inner surface 63 of the wall 62 defines a seating cavity 68. A perimeter of the seating cavity 68 substantially corresponds to an outer perimeter of the energy device 100. For example, as shown in the embodiment of FIG. 2, the wall 62 is annular and forms the seating cavity 68 having a circular shape to correspond to an energy device 100 having a circular cross sectional shape. Also, as shown, the channel 66 is annular. However, the wall 62 can be any shape as desired to correspond to the outer perimeter of the energy device 100 as desired such as rectangular, triangular, ovular, etc. The channel 66 can also have any shape as desired to correspond to the shape of the wall 62 and the sidewall 20 of the first housing portion 12. As shown, the wall 62 has a height that is less than a height of the first housing portion 12. However, the height of the wall 62 can be equal to the height of the first housing portion 12.

The retaining feature 60 can further include a storage wall 70 extending from the inner surface 24 of the first housing portion 12. The storage wall 70 includes an intermediate portion 72 integrally formed with and continuous with a portion of the wall 72, and two channel portions 74. The two channel portions 74 are disposed within the channel 66 and extend substantially perpendicularly with respect to the base wall 17 of the first housing portion 12. Each of the channel portions 74 is integrally formed with and extend between the inner surface 24 of the first housing portion 12 and the outer surface 64 of the wall 62. The channel portions 74 segment the channel 66 into a storage cavity 76 and a partial channel 78. The intermediate portion 72 can have any shape as desired to correspond to the outer perimeter of the energy device 100. For example, as shown, the intermediate portion 72 of the storage wall 70 can have a semi-circular shape to correspond to the energy device 100 having a circular cross sectional shape. As shown, the storage wall 70 has a height greater than the height of the wall 62 and less than the height of the first housing portion 12. However, the height of the storage wall 70 can be equal to the height of the wall 62 or equal to the height of the first housing portion 12, or any height as desired.

The container 10 can have various dimensions to facilitate compactness of the container 10 and portability of the energy device 100, In a non-limiting example, the diameters dₛ₁ of the sidewall 20 of the first housing portion 12 and the diameter dₛ₂ of the sidewall 40 of the second housing portion 14 can be equal to about 2 inches and a length l_{c} of the container 10 can be equal to about 4.25 inches to facilitate the container 10 being handheld. However, the container 10 can have any dimensions configured to retain the energy device 100 and to facilitate portability such as diameters dₛ₁, dₛ₂ of the sidewalls 20, 40 greater than or less than 2 inches and a length l_{c} of the container 10 greater or less than 4.25 inches. The container 10 can be formed from any durable material such as plastic and formed from any process such as a blow molding process, wherein the first housing portion 12 and the second housing portion 14 are molded separately. However, the container 10 can be molded such that the first housing portion 12 and the second housing portion 14 are formed integrally and then separated after the molding process by any separating means such as a cutting knife, a drill, a machine, or a laser cutter, for example. The container 10 can also be formed, wherein the first housing portion 12 and the second housing portion 14 are either separately formed or integrally formed and thereafter separated, from any process as desired such as an injection molding process or extrusion process, for example. The container 10 can also be composed of any material as desired such as metal, ceramics, or glass and formed from any metal forming process, ceramic forming process, or any blowing, pressing or glass forming process.

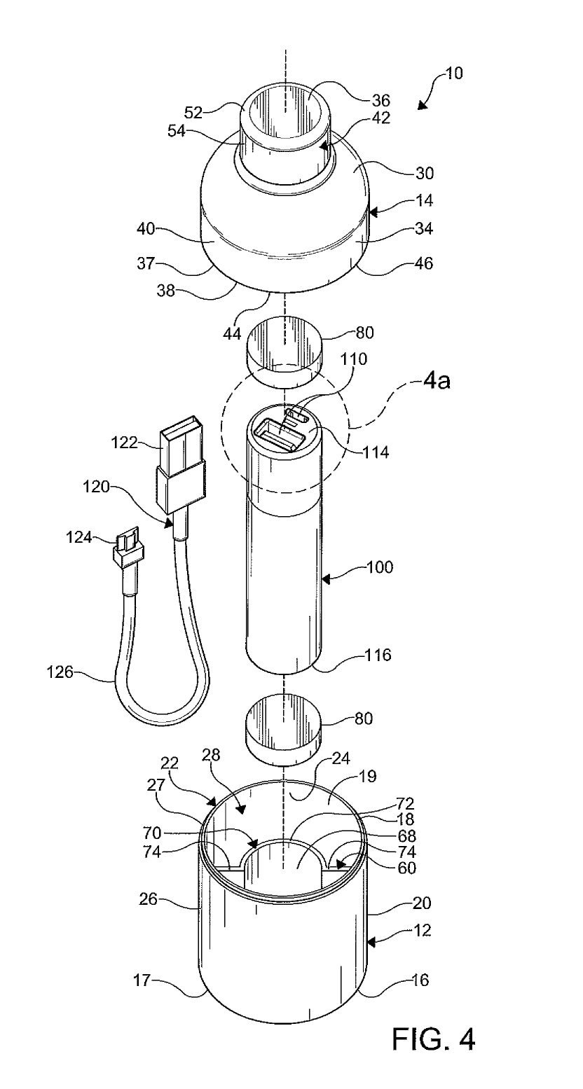

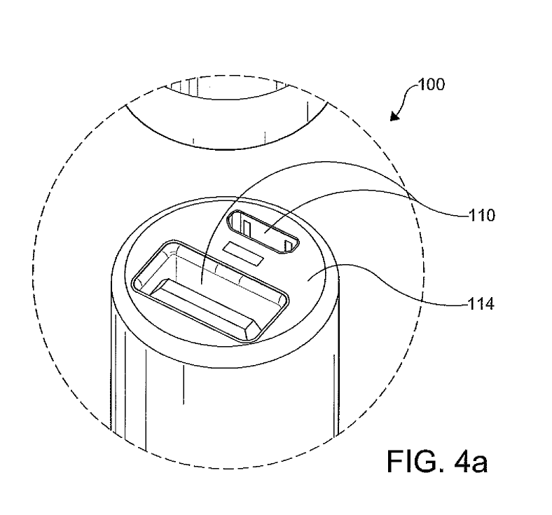

As shown in FIGS. 4 and 4a, the container 10 is configured to retain and store the energy device 100. The energy device 100 provides an energy source for an electronic device. In the embodiment shown, the energy device 100 is a battery configured to provide electrical energy to charge a battery of the electronic device when the electronic device has less than a complete charge. The energy device 100 can be any type of battery such as an 18650 battery, for example. The energy device 100 shown has a substantially cylindrical shape, although the energy device 100 can be any battery having any shape now known or later developed such as a rectangular prism, planar, or an ovular shape for example. In another non-limiting example, the energy device 100 can have a shape substantially corresponding to a shape of the container 10. It is understood the energy device 100 can be integrally formed with the container 10 or the energy device 100 can be at least a portion of the container 10, wherein the portion of the container 10 is configured to provide an energy source.

The container 10 may also be configured to retain and store an adaptor 120 for engaging the energy device 100 with the battery of the electronic device for charging. The adaptor 120 includes a first connector 122 for engaging with the energy device 100 and a second connector 124 for engaging with the electronic device. The first connector 122 for the energy device 100 and the second connector 124 for the electronic device are coupled by an electrical cord or wire 126. However, the connectors 122, 124 can be coupled by any coupling means such as a support structure (not shown). Additionally, the second connector 124 for engaging with the electronic device can be integrally formed with the energy device 100 such that the energy device 100 can be directly connected to the electronic device.

The energy device 100 can include adaptor ports 110 for receiving the first connector 122 of the adaptor 120. The adaptor ports 110 can be configured to receive adaptors 120 for any type of electronic device. In a non-limiting example, one of the adaptor ports 110 of the energy device 100 can be configured to receive a female connector 122 of a universal serial bus (USB) adaptor. In another non-limiting example, another one of the adaptor ports 110 can be configured to receive an adaptor to recharge the energy device 100 for further uses such as an adaptor that connects the energy device 100 to an energy source such as a power outlet. The energy device 100 can have any number of adaptor ports 110 configured to various types of adaptor used for charging electronic devices such as mobile phone, tablets, portable computers, game consoles, and cameras for example.

The container 10 can further include supports 80 configured to facilitate protecting the energy device 100 from damage. One of the supports 80 can be disposed within the cavity 28 of the first housing portion 12 such as within the seating cavity 68 of the retaining feature 60 and an other of the supports 80 can be disposed in the cavity 35 of the second housing portion 14 such as adjacent to the cap 52 of the neck 42. In the embodiment shown, the supports 80 are circular disc shaped. However, the supports 80 can be any shape as desired such as rectangular, triangular, ovular, or any other shape as desired. The supports 80 can be composed of a foam material, a plastic material, a fabric material, or any other material to protect the energy device 100 from damage.

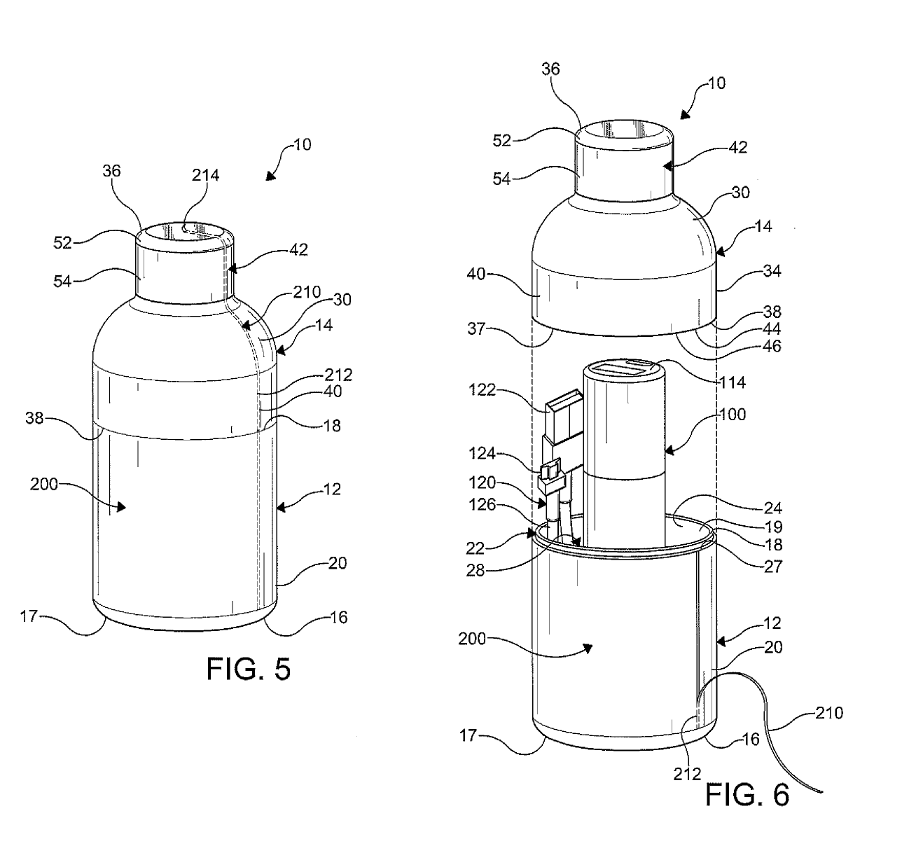

As shown in FIGS. 5 and 6, the container 10 further includes an outer layer 200 disposed thereon. The outer layer 200 at least partially encompasses the container 10. The outer layer 200 is form fit to the container 10 and removeably seats the first housing portion 12 to the second housing portion 14. The outer layer 200 at least encompasses the container 10 where the first housing portion 12 interfaces the second housing portion 14 and maintains the lip 22 of the first housing portion 12 in alignment with the lip 44 of the second housing portion 14. Further, the outer layer 200 militates against a separation of the first housing portion 12 from the second housing portion 14 and an axial movement of the first housing portion 12 in respect of the second housing portion 14. The outer layer 200 can be a film of material to removeably seat the first housing portion 12 to the second housing portion 14 such as plastic shrink wrap film that shrinks tightly to the container 10 upon an application of heat thereto, a plastic stretch wrap film, an adhesive film or cover, or any other material to removeably seal the first housing portion 12 together with the second housing portion 14, for example.

The outer layer 200 can include a tear strip 210 formed thereon to facilitate removal of the outer layer 200 from the container 10. The tear strip 210 includes perforated tear lines 212. The tear strip 210 can also include a pull tab 214 to facilitate gripping and tearing of the tear strip 210. In the embodiment shown in FIG. 5, the outer layer 200 encompasses the entire container 10. However, the outer layer 200 can partially encompass the container 10, as desired. The tear strip 210 extends longitudinally along the outer layer 200 of the container 10 from a portion of the neck 42 of the second housing portion 14 to a portion of the base wall 17 of the first housing portion 12. However, it is understood the tear strip 210 can be formed to extend in any direction as desired. For example, the tear strip 210 can extend along a circumference of the container 10, for example. The outer layer 200 can include indicia corresponding to pictures or information regarding the container 10, the energy device 100, or other identifying information such as a brand name, trademark, or company name for example.

In application, as illustrated in FIG. 4, the container 10 is configured for retaining a non-liquid material such as the energy device 100. To assemble the container 10, the first housing portion 12 of the container 10 receives at least a portion of the energy device 100 within the cavity 28 of the first housing portion 12. The first housing portion 12 of the container 10 is also configured to receive at least a portion of the adaptor 120. Where the container 10 includes the retaining feature 60, the energy device 100 is received in the seating cavity 68 to support and stabilize the energy device 100 from substantial movement within the container 10. In an embodiment of the invention where the storage wall 70 is included with the retaining feature 60, the storage wall 70 further supports and stabilizes the energy device 100. The storage cavity 76 formed by the retaining feature 60 is configured to receive the adaptor 120 or any other accessory.

Once the energy device 100 is received in the first housing portion 12, the second housing portion 14 can be positioned to abut the first housing portion 12 wherein at least a portion of the energy device 100 is also received within the cavity 35 of the second housing portion 14. The lip 44 of the second housing portion 14 abuts with and is aligned with the lip 22 of the first housing portion 12 to align the first housing portion 12 with the second housing portion 14. The male step 37 of the lip 44 of the second housing portion 14 is received in the groove 27 of the lip 22 of the first housing portion 12. The neck 42 further facilitates supporting and stabilizing the energy device 100 within the container 10 and militates against movement of the energy device 100 within the container 10. The energy device 100 is received in the cavity 35 of the second housing portion 14 wherein a surface 114 of the energy device 100 is adjacent the cap 52 of the neck 42 when the first housing portion 12 abuts the second housing portion 14. The supports 80 can be positioned in the container 10 to militate against damage to the energy device 100. One of the supports 80 can be positioned intermediate the cap 52 of the neck 42 and the surface 114 of the energy device 100. The other of the supports 80 can be positioned intermediate the base wall 17 of the first housing portion 12 and an opposing surface 116 of the energy device 100. The neck 42 is substantially aligned with the retaining feature 60 so that when the energy device 100 is received in both the first housing portion 12 and the second housing portion 14, the energy device 100 is arranged substantially perpendicular in respect of the base wall 17 of the first housing portion 12 and is stabilized by the retaining feature 60 and the neck 42.

Once the energy device 100 is disposed within the container 10 and the second housing portion 14 is aligned with the first housing portion 12, the outer layer 200 can be disposed on the container 10 to encompass at least a portion of the container 10 to releasably seal the first housing portion 12 in alignment with the second housing portion 14. As assembled, the container 10 is substantially fluid impermeable. After the outer layer 200 is formed on the container 10, the energy device 100 remains retained within the container 10. When the energy device 100 is needed by a user to charge the battery of an electronic device, as shown in FIG. 5 and FIG. 6, the user can grip the pull tab 214 of the tear strip 210 pulling the tear strip 210 along the perforated tear lines 212 so the outer layer 200 can be easily removed from the container 10. The second housing portion 14 can then be separated or removed from the first housing portion 12 (as shown in FIG. 6) and the energy device 100 and/or adaptor 120 can be removed from the container 10. The energy device 100 can be engaged with the adaptor 120 to connect the energy device 100 to the electronic device to charge the battery of the electronic device. The energy device 100 can be configured to provide up to eight hours of charge to the battery of the electronic device. However, the energy device 100 can be configured to charge any increment of charge to the battery of the electronic device such as more than or less than eight hours. The energy device 100 can also be charged by connecting the energy device 100 to a power source for further uses.

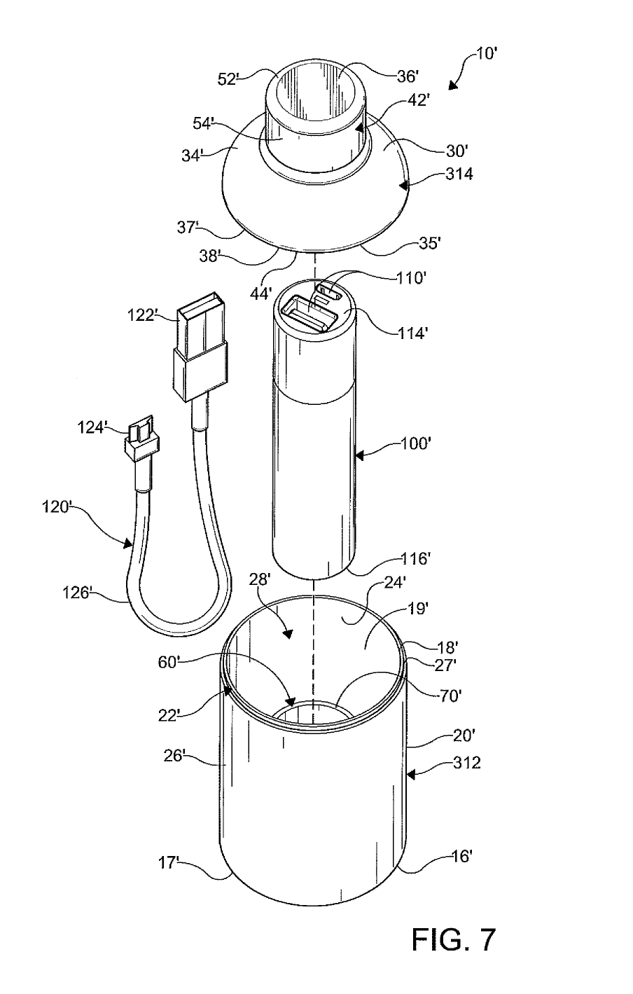

In application, the two-part housing configuration of the container 10, wherein the container 10 includes the first housing portion 12 and the second housing portion 14, facilitates insertion of the energy device 100 into the container 10 and effortless removal of the energy device 100 from the container 10. However, FIG. 7 illustrates a portable storage container 10′ according to another embodiment. Structure similar to that illustrated in FIGS. 1-4 includes the same reference numeral and a prime (′) symbol for clarity. The container 10′ includes a first housing portion 312 including the base wall 17′ and the sidewall 20′ integrally formed together to form a first part of the two-part housing configuration of the container 10′. The container 10′ also includes a second housing portion 314 including the neck 42′ integrally formed with the shoulder 30′ to form a second part of the two-part housing configuration to allow insertion of the energy device 100′ into the container 10′ and removal of the energy device 100′ from the container 10′. According to this embodiment, the shoulder 30′ includes the lip 44′ defining the opening 46′ of the second housing portion 314. The lip 44′ is configured to abut the lip 22′ of the first housing portion 312 and align the first housing portion 312 with the second housing portion 314. The lip 44′ includes the male step 37′ to be received in the groove 27′ of the lip 22′ of the first housing portion 312. The first housing portion 312 can include the retaining feature 60′ to stabilize the energy device 100′ within the container 10′.

In application, to assemble the container 10′, at least a portion of the energy device 100′ and or the adaptor 120′ is received in the first housing portion 312 within the cavity 28′ of the first housing portion 312. To assemble, once the energy device 100′ and/or adaptor 120′ is received in the first housing portion 312, the second housing portion 314 can be positioned to abut the first housing portion 312 so at least a portion of the energy device 100′ and/or adaptor 120′ is also received within the cavity 35 of the second housing portion 314. The fully assembled container 10′ is similar in structure to the fully assembled container 10 illustrated in FIG. 1. However, the second housing portion 314 of the container 10′ of FIG. 7 does not include the sidewall 40′.

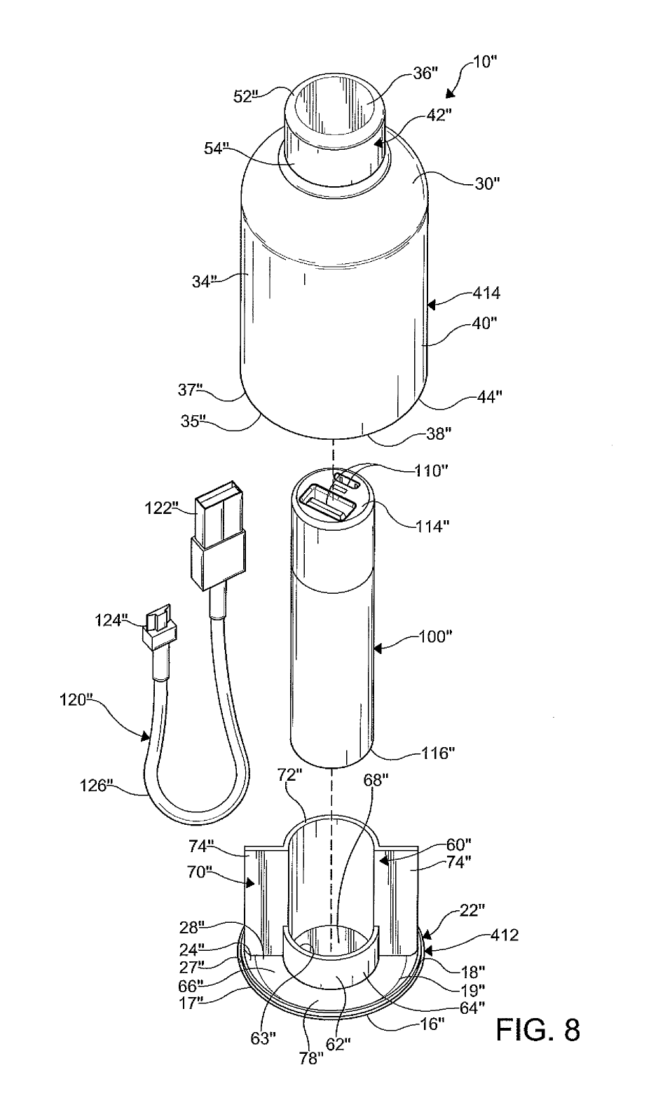

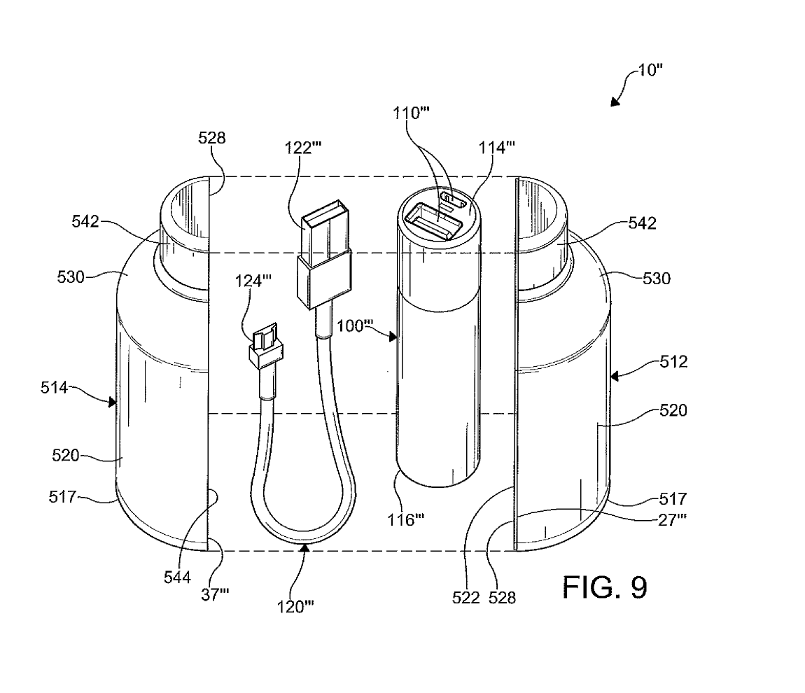

FIG. 8 illustrates a container 10″ according to another embodiment. Structure similar to that illustrated in FIGS. 1-4 includes the same reference numeral and a double prime (″) symbol for clarity. The container 10″ includes a first housing portion 412. The first housing portion 412 is the base wall 17′. The base wall 17″ forms the first part of the two-part housing configuration of the container 10″. The second housing portion 414 includes the sidewall 40″, the shoulder 30″, and the neck 42″ integrally formed together to form the second part of the two-part housing configuration to allow insertion of the energy device 100″ into the container 10″ and removal of the energy device 100″ from the container 10″. According to this embodiment, the sidewall 40″ includes the lip 44″ defining the opening 46″ of the second housing portion 414 and the base wall 17″ includes the lip 22″ of the first housing portion 412 wherein the lip 44″ of the second housing portion 414 is configured to abut the lip 22″ of the first housing portion 412 and align the first housing portion 412 with the second housing portion 414.

In application, to assemble the container 10″, at least a portion of the energy device 100″ and/or the adaptor 120″ is received in the first housing portion 412. Once the energy device 100″ and/or the adaptor 120″ is received in the first housing portion 412, the second housing portion 414 can be positioned to abut the first housing portion 412 such that at least a portion of the energy device 100″ and/or the adaptor 120″ is also received in the second housing portion 414. The fully assembled container 10″ is similar in structure to the fully assembled container 10 illustrated in FIG. 1. However, the first housing portion 412 of the container 10″ of FIG. 8 does not include the sidewall 20 of FIG. 1.

FIG. 9 illustrates a container 10′″ according to a further embodiment. Structure similar to that illustrated in FIGS. 1-4 includes the same reference numeral and a double prime (′″) symbol for clarity. The container 10′″ includes a first housing portion 512 and a second housing portion 514. Each of the first housing portion 512 and the second housing portion 514 includes a base wall portion 517, a sidewall portion 520, a shoulder portion 530, and a neck portion 542 integrally formed together forming a cavity 528 configured for retaining at least a portion of the energy device 100′″. The first housing portion 512 includes a lip 522 defining an opening of the cavity 528 of the first housing portion 512. The lip 522 of the first housing portion 512 is disposed along a longitudinal plane of the container 10′″. The second housing portion 514 includes a lip 544 defining an opening of the cavity 528 of the second housing portion 514. The lip 544 of the second housing portion 514 is disposed along a longitudinal plane of the container 10′″. The lip 544 of the second housing portion 514 is configured to abut the lip 522 of the first housing portion 512 and align the first housing portion 512 with the second housing portion 514. While not shown in FIG. 9, it is understood the first housing portion 512 and/or the second housing portion 514 can include a retaining feature to stabilize the energy device 100′″ within the container 10′″.

In application, to assemble the container 10′″, at least a portion of the energy device 100′″ and/or the adaptor 120′″ is received in the first housing portion 512. Once the energy device 100′″ and/or the adaptor 120′″ is received in the first housing portion 512, the second housing portion 514 can be positioned to abut the first housing portion 512 such that at least a portion of the energy device 100′″ and/or the adaptor 120′″ is also received in the second housing portion 514. The fully assembled container 10′″ is similar in structure to the fully assembled container 10 illustrated in FIG. 1. However, as shown in FIG. 9, the lip 522 of the first housing portion 512 and the lip 544 of the second housing portion 514 is disposed along a longitudinal plane of the container 10′″.

It is understood that the first housing portion 12, 312, 412, 512 and the second housing portion 14, 314, 414, 514 can be configured to form a container 10, 10′, 10″, 10′″ with a multi-part housing configuration in any way as desired, wherein any number of housing portions can be formed and the housing portions can be separated and joined at any location on the container and in any way desired. Also in further embodiments of the invention, the first housing portion 12, 312, 412, 512 can be integrally formed with the second housing portion 14, 314, 414, 515 to form the cavity configured to contain the energy device 100, 100′, 100″, 100″. Additionally, at least a portion of the container 10, 10′, 10″, 10′″ can be configured to be an energy device to provide an energy source. For example, at least one of the first housing 12, 312, 412, 512 and the second housing 14, 314, 414, 514 can be configured to be an energy device. While not shown in FIGS. 7, 8, and 9, it is also understood that the containers 10′, 10″, 10′″ can include the outer layer 200 to releasably seal the first housing portion 312, 412, 512 to the second housing portion 314, 414, 514.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A container for storing an electrical energy device comprising:
a first housing portion; and
a second housing portion cooperating with the first housing portion to form a cavity configured to receive the energy device therein, at least one of the first housing portion and the second housing portion having a generally cylindrical shape with a neck and a shoulder formed adjacent a first end thereof.

2. The container of claim 1, wherein at least a portion of the cavity has a shape substantially corresponding to a shape of the energy device.

3. The container of claim 1, wherein the first housing portion includes at least a base wall and a sidewall integrally formed with the base wall.

4. The container of claim 1, wherein each of the first housing portion and the second housing portion include a base wall portion, a sidewall portion, a shoulder portion, and a neck portion integrally formed together.

5. The container of claim 1, wherein the first housing portion is a base wall.

6. The container of claim 1, wherein the first housing portion includes a retaining feature, the retaining feature defining a seating cavity having a perimeter substantially corresponding to a shape of the energy device.

7. The container of claim 1, wherein the first housing portion includes an inner surface and a storage wall extending from the inner surface to form a storage cavity for receiving an adaptor.

8. The container of claim 1, further comprising an outer layer at least partially encompassing the first housing portion and the second housing portion and releasably seating the first housing portion to the second housing portion.

9. The container of claim 1, further comprising an energy device received in the cavity.

10. The container of claim 1, further comprising at least one support disposed within the cavity.

11. The container of claim 1, wherein one of the first housing portion and the second housing portion includes a groove formed thereon and an other of the first housing portion and the second housing portion includes a male step formed thereon, the groove receiving the male step to militate against relative movement between the second housing portion and the first housing portion.

12. A container for storing an electrical energy device comprising:
a first housing portion;
a second housing portion cooperating with the first housing portion to form a cavity configured to receive the energy device therein; and
an outer layer at least partially encompassing the first housing portion and the second housing portion and releasably seating the first housing portion to the second housing portion.

13. The container of claim 12, wherein the first housing portion includes at least a base wall and a retaining feature extending from the base wall, the retaining feature defining a seating cavity having a perimeter substantially corresponding to a perimeter of the energy device.

14. The container of claim 12, wherein each of the first housing portion and the second housing portion include a base wall portion, a sidewall portion, a shoulder portion, and a neck portion integrally formed together.

15. The container of claim 12, further including an energy device received therein, the energy device including at least one port configured to receive an adaptor.

16. The container of claim 12, wherein the cavity retains a non-liquid material.

17. The container of claim 12, wherein at least at portion of the container is an energy device.

18. An electrical energy device comprising:
a first end and a second end;
at least one of a neck and a shoulder formed adjacent the first end; and
a generally cylindrical portion formed adjacent the second the second end, wherein at least a portion of one of the neck, the shoulder, and the generally cylindrical portion is configured to provide an electrical energy source.

19. The electrical energy device of claim 18, further comprising at least one adaptor port configured to receive an adaptor.

20. The electrical energy device of claim 18, further comprising an outer layer encompassing at least a portion of the electrical energy device.
